(19) United States
(12) Patent Application Publication
(10) Pub. No.: US 2011/0250441 A1
(43) Pub. Date: Oct. 13, 2011

(54) HIGH-BARRIER COMPOSITES AND METHOD FOR THE PRODUCTION THEREOF

(76) Inventors: Sabine Amberg-Schwab, Erlabrunn (DE); Klaus Noller, Tiefenbach (DE); Ulrike Weber, Waldbrunn (DE); Oliver Miesbauer, Pfaffenhofen (DE)

(21) Appl. No.: 13/139,662

(22) PCT Filed: Dec. 15, 2009
(86) PCT No.: PCT/EP2009/067194

§ 371 Date: Jun. 14, 2011

(30) Foreign Application Priority Data
Dec. 19, 2008 (DE) 10 2008 063 974.5
Jun. 23, 2009 (EP) 09163519.3

(51) Int. Cl. B32B 3/00; B29C 65/14; C09J 5/00

(52) U.S. Cl. 428/332; 156/324; 156/272.2

(57) ABSTRACT

The invention pertains to a high-barrier composite, comprising a substrate, a first layer made of an exclusively inorganic material, a first layer made of an inorganic-organic hybrid material, and a second layer made of an exclusively inorganic material, characterized in that the layer made of inorganic-organic hybrid material is arranged directly between the two layers made of exclusively inorganic material and has a thickness of less than 1 μm. The composite can be produced using the steps wherein the layer or layers made of inorganic-organic hybrid material is/are applied to the [sic, word missing—substrate?—Tr.] coated with inorganic material by means of applying a lacquer material with a viscosity of 0.002 Pas to 0.02 Pas and/or a surface tension in the range of 25 mN/m to 35 mN/m or a laminating material with a viscosity of 0.1 Pas to 200 Pas, wherein the substrate is transported without contact with the means effecting the transport.

The present invention pertains to multilayer systems on flexible or rigid substrates with extremely high barrier properties against the permeation of water vapor, oxygen and migratable monomers. The multilayer systems are made up of at least two inorganic layers (e.g., sputtered layers) and an intermediate inorganic-organic hybrid polymer layer which has a diameter of less than 1 μm.

As a flexible packaging solution for sensitive food, polymer films are now available that have such low permeabilities against oxygen and water vapor in conjunction with a vacuum-deposited layer made of Al, AlOₓ or SiOₓ that this food can be protected against oxidation, moisture development or loss within the shelf life. Vapor-deposited layers are produced industrially in large quantities and they are available at favorable prices. Depending on the film quality and the respective inorganic layer, they obtain (in relation to a 12-μm PET film with an inorganic layer) permeabilities up to less than 1 cm³/m²d bar (O₂) and 0.5 g/m²d (H₂O).

These film composites are not sufficient for industrial applications with high requirements on the barrier properties (encapsulation films for OLEDs and organic solar cells). In the present state of the art, the improvement of the barrier with single inorganic layers is limited by defects. Hence, for the application area of ultrabarrier films, one moved on to developing multilayer structures: Inorganic barrier layers, applied by a PVD process, are combined with leveling, usually organic intermediate layers, which smooth the surfaces, cover growth defects in layers lying thereunder, and guarantee the flexibility of the entire layer structure. As material for these intermediate layers, U.S. Pat. No. 6,570,325 B2 suggests a range of polymer systems, which at first glance comprises almost all monomers and prepolymers, which might be suitable particularly for layered application and for later crosslinking. The focus lies on the vacuum application process; however, materials are also mentioned which are applied as a liquid phase to the respective substrate. The layer thickness is indicated as randomly selectable, wherein a concretely mentioned thickness range, namely 1,000-10,000 Å, is mentioned with regard to materials to be applied from the gas phase. Such thin layers cannot be produced with the liquid application process indicated, at least not as uncoupler layers without the findings of the present invention, namely in the intended roll-to-roll process: While spin coating is not suitable for the production of rolls at all, uneven surfaces are obtained with spray processes.

Further barrier films are disclosed in WO 08/122,292, US 2006/0063015, US 2008/196664, US 2008/305359, U.S. Pat. No. 7,442,428, US 2008/167413, U.S. Pat. No. 7,449,246, US 2007/224393, US 2008/237615, EP 1384571 B1 and EP 1563989.

A method for forming thin liquid layers on flexible substrates made of polymers and/or metals has become known from EP 1975214 A1.

In practice, acrylates are usually used for the intermediate layers. Since these layers represent only an insufficient barrier, currently approx. five pairs of layers have to be used to achieve a reduction in the permeation by several orders of magnitude. Above all, the firm Vitex Systems, USA, offers such systems commercially worldwide, see Affinito, J., Hilliard, D.: “A New Class of Ultra-Barrier Materials,” Proc. 47^{th} Anspruch. Tech. Conf., Dallas, Apr. 2004, Society of Vacuum Coaters, Albuquerque (2004), pp. 563-593.

The firm General Atomics, who developed a roll-to-roll process for coating flexible PC films with aluminum oxide (approx. 80 nm), follows a different concept. Water vapor barrier values of 10⁻⁴ g/m²d should be available by means of a single coating. A calcium mirror test shows a breakdown of the calcium layer to the half surface at 85° C. and 85% air humidity after approx. 200 hr. In this case, these barrier layers are applied on the outside of the carrier material of the OLED, and the OLED are again provided with an 80-nm-thick layer of aluminum oxide (see http://displayproducts.ga.com/pdf/High%20Performance%20Barrier.pdf).

It has been known for many years that the barrier properties of polymer films coated with metals or ceramics, e.g., metal oxides, can be drastically improved by additional application of an inorganic-organic hybrid polymer layer. Inorganic-organic hybrid polymers that contain silicon atoms are also designated as organically modified silicic acid polycondensates; they can be synthesized via the so-called sol-gel process and have an inorganic network, usually formed by hydrolytic condensation of corresponding silanes, as well as organic substituents and possibly heteroatoms in the inorganic network. The organic substituents may possibly form another, organically linked network, which interpenetrates the inorganic network, which is formed by means of polymerization of organically polymerizable substituents at the silicon atoms or at some of the silicon atoms, and possibly in the presence of copolymerizable, purely organic components. These materials have become widely known under the trademark names ORMOCER®e, registered for the applicant of the present invention. Packaging materials with such barrier layer combinations are known DE 19659286 C2 or EP 802218 B1. Here, the barrier layers are usually applied as a wet lacquer and have a thickness of 1 μm to 15 μm.

Extreme barriers against the gases present in the natural environment such as oxygen and against air humidity are needed for a number of applications, e.g.: flexible encapsulation of OLEDs and solar cells. As likewise mentioned above, such barriers can only be produced by multilayer structures, which is extremely cost-intensive.

The object of the present invention is to provide as ultrabarriers suitable layer composites, which have extremely low water vapor permeabilities and preferably also very low oxygen permeabilities with a low number of layers.

The inventors of the present invention observed several effects, from which they could derive the unexpected result that especially good barrier properties are not obtained with markedly thicker intermediate layers, and that it is not necessary to pack a large number of layers on one another to obtain high-barrier composites. Quite the reverse: Very good barrier properties can already be obtained by a barrier composite which consists of a combination of the respective substrate with at least one, preferably two inorganic barrier layers and at least one inorganic-organic hybrid polymer intermediate layer, which is applied very thin, i.e., with a thickness of less than 1 μm, preferably of less than 500 nm and especially preferably of less than 200 nm or even of less than 100 nm, to the respective substrate or inorganic barrier layer lying under it, when this is embodied as a well-sealing layer. This finding could therefore only be obtained because the inventors provide a method for the first time that makes possible the uniform application of such thin hybrid polymer layers. This could not be done up to now, especially for continuous methods, such as the roll-to-roll method.

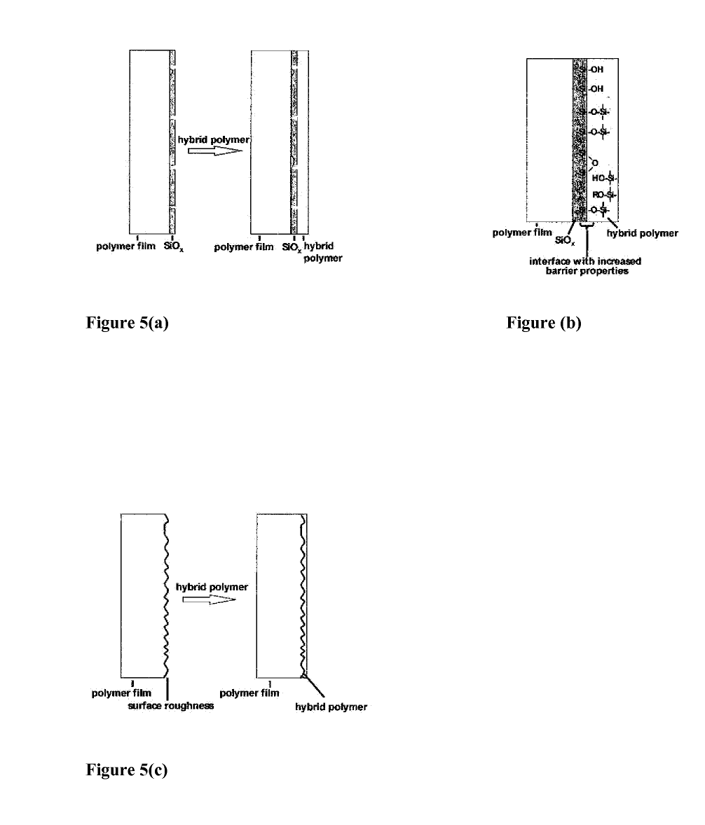

FIG. 5 shows, in principle, the advantageous properties that already arise in barrier composite films made of only one pair of layers, an inorganic barrier layer and an inorganic-organic hybrid polymer layer, applied to the substrate. Figure (a) shows that applying a wet lacquer layer made of an inorganic-organic hybrid polymer material to an inorganic barrier layer (here made of SiOₓ in the example) covers and levels its voids or pinholes. The macroscopic defects are consequently partly compensated. This effect is already well known from the state of the art. Figure (b) schematically shows the good adhesion of an Si—O-containing inorganic-organic polymer layer to a silicon oxide layer because of the Si—O—Si bonds forming at the interface. This principle applies to other metal oxides as well, since other M-O-M or Si—O-M bonds also have the same effect; in the meantime, it could be experimentally confirmed by the inventors using a layered structure with an aluminum oxide layer which borders on an inorganic-organic hybrid layer containing silicon atoms. Even in pure metal layers as inorganic layers, this effect can be observed, because the metals likewise form hydroxyl groups on their surface. It is especially important that the hybrid polymer layers can be formed using low-viscosity lacquer with a very low roughness (<0.5 nm), which makes it possible to apply a low-defect inorganic layer thereto. For this reason, a hybrid polymer layer may also be used to planarize a rough surface. This is of special interest for some organic substrates, since many organic films have an extremely rough surface.

In summary, it can be stated that the inventors succeeded in providing hybrid polymer layers with very good layer adhesion to inorganic layers as well as very smooth surfaces, which contribute to the barrier action described below. These layers are produced by applying lacquers or laminating adhesives having excellent flow properties. Because of the low viscosities of the lacquers, it is conceivable that the lacquers flow into the defects of the inorganic layer lying thereunder, possibly under the effect of the capillary action. This filling of defects leads to an additional barrier action of the coated barrier films.

Based on these findings, the object of the present invention is preferably accomplished by providing layer composites, in which an inorganic-organic hybrid layer is surrounded by a purely inorganic barrier layer on both sides. The barrier properties are even much better in these layer composites compared to those made of a hybrid layer in combination with only one inorganic layer.

Furthermore, the inventors were able to show with numerical calculations that the barrier action of such a system against permeating oxygen—and also somewhat weaker against permeating water vapor—can be markedly improved if the thickness of the hybrid layer is reduced. This completely surprising effect can probably be explained as follows.

The permeation of a gas through a barrier or a substrate, for example, a plastic film with a certain permeability for permanent gases from one space with higher concentration of this gas into a space with lower concentration of the gas, is determined by the adsorption of this gas at the surface of the film, its absorption in the film material, diffusion through the film material and desorption from the film material into the second space. The moving force for the permeation is the partial pressure difference of the gas between these two spaces. The permeability of a homogeneous polymer film for the gas can be described by the permeation coefficient P. This is the product of the solubility coefficient S of the gas in the polymer and the diffusion coefficient D. It is independent of the thickness of the film. The permeability Q of the film then results in being Q=P/d (d=thickness of substrate). The film may be considered to be resistance. If two such films or layers are connected in series, then the total permeability Q follows Kirchhoff's rule, i.e., 1/Q=1/Q₁+1/Q₂, wherein Q₁ and Q₂ are the permeabilities of the two layers. From this it can be derived that the layer with the lowest permeability has the greatest action for the composite.

Purely inorganic barrier layers, such as layers of metals or metal oxides, which are applied (vapor-deposited) from the gas phases, are theoretically completely gastight, even if they are very thin. In practice, this is not true, however, because the applied layers have voids or defects, through which gases can permeate. The impermeability of the inorganic barrier layer cannot be randomly increased by an increase in the thickness of the material and even decreases again from a certain thickness. The barrier improvement, which is achieved by applying such a layer to a polymer, is designated as BIF (barrier improvement factor; the permeability of the vapor-deposited polymer divided by the permeability of the non-vapor-deposited polymer). 1/Q=BIF (1/Q₁+1/Q₂), wherein Q₁ and Q₂ are the permeabilities of the non-vapor-deposited substrate polymer or the non-vapor-deposited hybrid polymer, applies to the permeability Q of a polymer/inorganic barrier layer/substrate polymer composite. This means that the BIF acts on the hybrid polymer layer in exactly the same way as on the substrate polymer. Since the vapor-deposited layers are not absolutely impermeable because of defects, as mentioned, their actual impermeability depends on, among other things, the surface planarization of the layer lying thereunder. The barrier action of a not purely inorganic, i.e., polymer or hybrid polymer layer, which is in contact with exactly one inorganic layer, increases with its layer thickness. Beginning from a critical layer thickness, however, marked rates of increase are no longer obtained.

Surprisingly, this behavior does not, however, apply to an inorganic-organic hybrid polymer layer, as can be provided by the inventors, between two purely inorganic barrier layers. In the permeation of a gas, e.g., O₂, through such a multilayer, the gas molecules penetrate through a defect of the one inorganic layer into the hybrid polymer layer, migrate in this essentially parallel to the layer surface to a defect of the second inorganic layer, and leave the hybrid polymer layer through this defect. Since the permeability of the hybrid polymer layer parallel to the layer surface is approximately proportional to the cross-sectional area for this diffusion, i.e., approximately proportional to the thickness of the hybrid polymer layer, the barrier action of the multilayer can be markedly increased by reducing this thickness. In other words: It does not depend on the length of the path from the entry surface of a gas molecule to the nearest point on the opposite side, but rather on the cross-sectional area, which is offered to the gas molecules as an entry surface for diffusion along the layer surface. The lower the volume of the layer is, the fewer gas molecules can diffuse through per time unit. In two-dimensional layer structures, it is clear that the thickness of the layer determines this volume. Therefore, the higher the diffusion barrier is, the less material the inorganic-organic barrier layer has, i.e., the thinner it is.

The prerequisite for this effect, which is designated as tortuous path effect, is the offsetting of the defects of the two inorganic layers in relation to the defects of the first inorganic layer. This is achieved by the intermediate layer, since this layer covers the defects of the first inorganic layer and hence brings about an uncoupling of the defects of the two inorganic layers. Besides this effect, the well-known uncoupling effect already mentioned above plays a role, of course. However, this uncoupling effect is also enhanced by the barrier composites produced according to the present invention. As a rule of thumb, it may namely be true that the thickness of the polymer intermediate layers is preferably not greater (and more preferably markedly smaller) than half the diameter of the defects or pinholes in the inorganic layers.

The inventors succeeded in producing coating lacquers or laminating compounds with excellent flow properties, which have such viscosities that they are capable of flowing (of being “absorbed”) into same because of the large surfaces in the defects and the capillary action resulting therefrom. Consequently, a more active uncoupling of these defects arises, which improves the barrier action extremely.

All in all, the permeability Q* of the inorganic layer/hybrid polymer layer/inorganic layer basic element of the barrier films according to the present invention depends on the following variables in a complicated manner:
size and frequency of defects in both inorganic layers,
average distance between a defect of one inorganic layer and the next defect of the other inorganic layer,
thickness of the hybrid polymer intermediate layer, and
standardized permeability Q₁₀₀ of the hybrid polymer intermediate layer as a scaling variable.
If the defects of the inorganic layer are filled, the permeability Q* also depends on the thickness of the inorganic layer.

These dependences of Q* were investigated by means of numerical simulations [O. Miesbauer, M. Schmidt, H.-C. Langowski, Transport of materials through layer systems made of polymers and thin inorganic layers, Vakuum in Forschung and Praxis, 20 (2008), No. 6, 32-40].

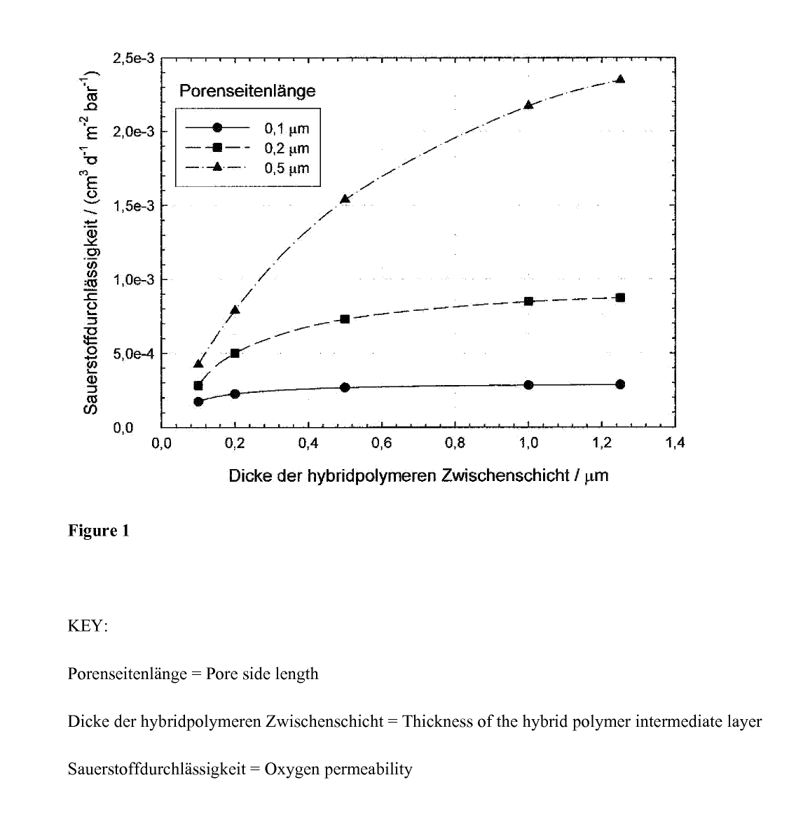

FIG. 1 shows the oxygen permeability of the inorganic layer/hybrid polymer intermediate layer/inorganic layer structure as a function of the thickness of the intermediate layer for different defect sizes and for a pore distance≈94 μm. In this case, the pores in the two inorganic layers are empty, periodically distributed and displaced against one another. It is seen that a reduction in the thickness of the intermediate layer at first leads to a considerable reduction in the permeability. Only when this thickness is small enough, is the permeability reduced upon further reduction in the thickness. The layer thickness, below which the permeability is reduced with decreasing thickness, increases with increasing defect size.

However, simpler relationships arise again for further layer sequences of this type: The doubling of the basic element by a five-layer structure with the layer sequence of inorganic layer—first hybrid polymer intermediate layer—inorganic layer—second hybrid polymer intermediate layer—inorganic layer yields the following in case the two polymer layers and the three inorganic layers are each identical:

Qₜₒₜₐₗ⁻¹=Q*⁻¹+Q*⁻¹ or Qₜₒₜₐₗ0.5Q*

Thus, the first sandwich structure achieves the greatest importance for the barrier properties of the finished layer system, since it may improve the barrier properties of the base film by many powers of ten, but the next layer sequence made of another inorganic-organic hybrid layer and another inorganic layer only by a factor of 2. This applies analogously to other pairs of layers in alternating layer systems of inorganic and hybrid polymer layers.

The following consequences arise for the manufacture of high- or ultrabarriers:
As in the layer systems considered above, the production of inorganic layers with the lowest possible defect frequencies and the greatest possible defect distances is important. Such layers can be produced using the measures known in the state of the art.
Materials with the lowest possible standardized permeabilities for water vapor and oxygen (Q₁₀₀) should be used for the hybrid polymer intermediate layers.
The inorganic-organic, hybrid polymer intermediate layers must be applied in the smallest possible thicknesses (preferably ≦100 nm). However, the surface quality obtained must be high, and the defects on the substrate must especially not be reproduced by a too thin or poorly running layer on the surface thereof.

Because of the above-explained considerations of sandwich systems about the arrangement of a composite of inorganic and hybrid polymer layers on a substrate, further preferred embodiments of the present invention arise with the following approximate improvements in the barrier action observed on the basis of SiOₓ:

TABLE 1

| | Factor for reducing | |
|---|---|---|
| Effect | oxygen permeability | |
| Second SiOₓ/hybrid polymer pair | ≈2 | |
| Reduction in the thickness of the | | |
| hybrid polymer layer from | | |
| 1.5 μm to300 nm | <2 | |
| 100 nm | 2 | |
| 20 nm to 30 nm | 10 | |
| Reduction in the average defect size | [symbol] | Barrier action in defects |
| | | dominates => Q ≈ (pore size)² |
| | [symbol] | Barrier action in intermediate |
| | | layer dominates: see Figure 1 |
| Increase in the average | [symbol] | Barrier action in defects |
| defect distance | | dominates => Q ≈ 1/(pore size) |
| Increase in the thickness of the SiOₓ | [symbol] | Barrier action in defects |
| layer | | dominates => Q ≈ 1/thickness |
| | [symbol] | Barrier action in intermediate |
| | | layer dominates: see Figure 1 |

| | |
|---|---|
| Reduction in the permeation | Q ≈ Permeation coefficient |
| coefficient of hybrid polymer | |

It can be derived from Table 1 that an oxygen permeability of 10⁻³ cm³/(d·m²·bar) for the two-layer barriers according to the present invention can be achieved according to the present invention. Considered realistically, this is a factor of approx. 10 compared to the values that can be obtained up to now in the state of the art.

Further barrier improvements by [sic, “um um” should simply be “um”—Tr.Ed.] several orders of magnitude can be achieved by one or more of the measures listed below:
Further reduction in the thickness of the inorganic-organic hybrid polymer layer (provided that this layer continues to be closed)
Reduction in the porosity of the inorganic layer
Reduction in the permeation coefficient of the inorganic-organic hybrid polymer layer
Application of the inorganic-organic hybrid polymer layer under clean room conditions, cleaning of the film before application of individual layers.

The inorganic-organic hybrid polymers of the present invention are produced by using at least one silane of formula (I)

R¹ₐR²_{b}SiX_{4-a-b} (I),

wherein R¹ is a radical, which is available for an organic crosslinking/polymerization, R² is an (at least mainly) organic radical, which is not available for organic crosslinking/polymerization, and X denotes an OH group or a group that can enter into a condensation reaction with other such groups under hydrolysis conditions and thus contributes at least partially by binding to an oxygen atom of another silicon compound of formula (I) or another hydrolytically condensable silicon compound or a comparable compound of a metal to the inorganic crosslinking during the sol-gel formation. a and b may be 0, 1 or possibly even 2, 4-a-b may be 1 in rare cases, but is usually 2 or 3.

The radicals X are designated as inorganic network formers. The radicals R¹ are also designated as organic network formers, since they make possible the formation of an organic network in addition to the inorganic network formed by hydrolytic condensation. The radicals R² are designated as organic network modifiers, since they codetermine the properties of the hybrid polymers, without being incorporated into the network or networks.

X may be especially an alkoxy, hydrogen, hydroxy, acyloxy, alkylcarbonyl, alkoxycarbonyl and, in specific cases, even a primary or secondary amino group. Preferably, X is an alkoxy group, very especially preferably a C₁-C₄ alkoxy group. 4-a-b=3 is especially preferred.

The hybrid polymers may possibly still be produced by using (metalloid) metal alkoxides, which can be selected, e.g., from among boron, aluminum, zirconium, germanium or titanium compounds, but also from among other soluble, preferably alkoxide-forming main and transition metal compounds.

The embodiment of the present invention, in which 4-a-b=3, is therefore especially preferred, because the silane used, R¹SiX₃, has three inorganic crosslinking points, which lead to a high degree of crosslinking in the subsequent hydrolysis. The layers are thus more impermeable and more glass-like and hence have a higher intrinsic barrier action. Accordingly, hybrid polymers which contain such silanes exclusively are preferred.

For comparable reasons, instead of this, it may be preferred to use a silane of the formula (I) (or a combination of several such silanes) together with a silane of the formula SiX₄, wherein X has the same meaning as in formula (I). Again for comparable reasons, this applies to the combination of a silane of formula (I) with one (or more) metal alkoxide(s). Of course, the three above-mentioned preferred embodiments can also be combined with one another.

It is preferred according to the present invention (to be precise in combination with all embodiments mentioned above) that some of the silanes used for the production of hybrid polymers are those, in which a is equal to 1 or (in very rare cases) equal to 2. Accordingly, in specific embodiments of the present invention, such hybrid polymers are preferred as coating materials or laminating compounds for the present invention, which, besides the inorganic network, have an organic polymer network. Such a network may form, for example, by opening epoxy groups bound to R¹. Alternatives are, for example, radicals R¹, which contain acrylate, methacrylate or vinyl groups. An organic crosslinking can be brought about here, e.g., using UV radiation by means of polymerization (polyaddition) of the double bonds. Silanes with such or similar/comparable radicals R¹ are known in great numbers from the state of the art.

The starting materials are usually hydrolytically condensed or are partly condensed according to the known sol-gel process, whereby usually a catalyst initiates or accelerates the condensation reaction in the known manner. Coating materials produced in this manner are usually applied as lacquers (solutions, suspensions), which are subsequently cured by evaporation of the solvent, a continuous inorganic post-crosslinking and/or an organic crosslinking. When an organic crosslinking shall take place, a suitable catalyst or an initiator can be mixed with the lacquer as needed, and the crosslinking takes place thermally or using actinic radiation (e.g., UV or other light radiation), possibly even redox-catalyzed. An inorganic post-crosslinking is frequently linked with evaporation of solvents. All this has been known for a long time and has been set forth in writing in a large number of publications.

Preferably water, but possibly also an alcohol is used as a solvent. Water-based lacquers are to be preferred for environmental protection reasons.

Because of their intrinsic barrier properties, said hybrid polymers or lacquer/laminating materials have excellent barrier properties as well, when they are used in combination with inorganic barrier layers. The quality of the barriers can be further improved if the hybrid polymers also have, besides the inorganic polymer network, an organic polymer network. This double crosslinking structure distinguishes them very particularly from organic partial layers, e.g., made of acrylate, usually used in composites with ceramic material. The action of acrylate layers is based only on their intrinsic barrier action and on the uncoupling of several inorganic layers applied from the gas phase. On the other hand, hybrid polymer materials can additionally seal barrier layers made of inorganic material (metal or ceramic layers) lying thereunder, in that they can fill the voids (pinholes) thereof because they are have a relatively low viscosity. What likewise distinguishes them from organic layers is the ability to bind to surfaces of pure inorganic layers via metal-oxygen-metal bridges. This covalent binding further represents an intrinsic barrier action of the layer combination increasing the overall action. Because of the ability to bind covalently to inorganic layers, hybrid polymer layers that can be used according to the present invention also assume primer functions. Moreover, they have excellent uncoupling effects. Because of their ability to level defects and unevennesses of underlying layers, they can further function as planarization layers. Finally, they are completely curable: It is known from the state of the art that extremely scratch-resistant layers can be produced from such hybrid polymers.

The results for oxygen (OTR [oxygen transmission rate—Tr.Ed.]) and water vapor permeability (WVTR [water vapor transmission rate—Tr.Ed.] of specific film composites are shown in Table 2.

TABLE 2

| | | WVTR [g/m²d] |
|---|---|---|
| | | @ 38/90 |
| Film | Layer composition | (Ca test) |
| PET | AlOx | 4 × 10⁻² |
| PET | AlOx/lacquer (A) or (B) | 7 × 10⁻³ |
| PET | AlOx/lacquer (A) or (B)/AlOx | 1.0 × 10⁻³ |
| PET | AlOx/lacquer (A) or (B)/AlOx/lacquer (A) or (B) | 3 × 10⁻⁴ |
| PET | ZnSnOx/lacquer (A)/ZnSnOx | 2.0 × 10⁻⁴ |

Additional hybrid polymer layers of the above-mentioned type may function as protective layers, which are preferably applied in thicker layers (over 1 μm), for example, as UV protection or for the purpose of giving the composite moisture resistance. For this, such layers are usually applied as an outermost layer of the composite (“topcoat”).

Layers made of the inorganic-organic hybrid materials which can be used according to the present invention function accordingly in the barrier composite layers according to the present invention not only as barriers for gases and gaseous water, but also as a primer, planarization layer, uncoupling intermediate layer and protective layer with multiple protective properties. It should be mentioned only in passing that primer layers for the present invention might also consist of organic layers in particular cases instead of hybrid polymers.

Above all, metals and metal alloys, their oxides, nitrides and carbides, oxides, nitrides and carbides of silicon, as well as corresponding mixed compounds and other ceramic materials are suitable as materials for inorganic barrier layers. Aluminum or silicon oxides are favorable, for example. Also, silazanes are suitable. Depending on the material used and as needed, these are applied from the gas phase, for example, sputtered or vapor-deposited. Vacuum techniques or vacuum-free techniques may be used. Vapor deposition has the advantage of being less expensive and faster to carry out than sputtering. However, a higher density of the layer and thus a better barrier action of this layer can be obtained with the latter.

The inorganic-organic hybrid material of the present invention is applied from the liquid phase, e.g., by wet lacquer coating. Since the coating material has low viscosity, perfuses well and is chemically related to the inorganic barrier layers, at least some of the macroscopic and microscopic defects in the inorganic layers can be compensated and possibly the defects (pinholes) present both in vapor-deposited and in sputtered layers are filled. The barrier action improved by the synergy effect, i.e., barrier action improved by the filling of pores or by the covalent binding to inorganic layers, is the great advantage of wet chemically applied hybrid polymer intermediate layers compared to layer systems, in which all layers are applied from vacuum.

Usually, it is especially favorable to arrange first an inorganic barrier layer on the (or a) substrate surface and on that at least one layer made of an inorganic-organic hybrid material, followed by a second inorganic barrier layer. In such an arrangement, the permeation coefficient lies below the [sic, “der der” should be “der”—Tr.Ed.] reverse arrangement (substrate—inorganic-organic hybrid polymer—inorganic barrier) by one order of magnitude. However, this arrangement cannot be used in all cases without additional layers or without pretreatment. For example, the inorganic and hybrid polymer layers do not adhere to polytetrafluoroethylene. Fluorinated polyethylenes such as PTFE, PVF, ETFE are, however, frequently favorable as substrate materials, because they are transparent to UV light, are UV-resistant and thus are suitable for applications outdoors. Another drawback of these polymers is their high surface roughness. Therefore, in such cases, a layer made of inorganic-organic hybrid polymer is preferably applied as a primer to the substrate after corona pretreatment. This layer is used in addition to the sandwich composite consisting of inorganic layer/hybrid polymer layer/inorganic layer to be used according to the present invention.

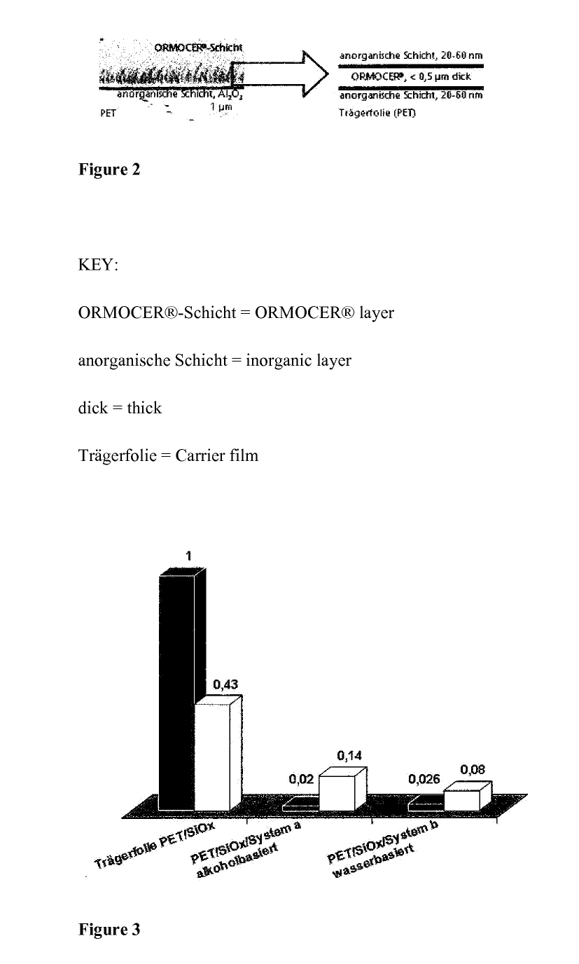

Barrier layer composites with the arrangement: inorganic layer/inorganic-organic hybrid polymer/inorganic layer achieve better barrier values, when the thickness of the inorganic-organic hybrid polymer layer is <1 μm, than when it lies above that, as shown above. Preferably, the thickness of this layer is less than 500 nm, in the ideal case even below 200 nm. Values of 50 nm are optimal, if a covering of the elevations in the topology of the inorganic layer vapor-deposited on the substrate can thus be achieved (see FIG. 2, the electron microscopic image of a common barrier composite and such an image of an arrangement according to the present invention with two inorganic layers and an intermediate inorganic-organic hybrid polymer layer can be seen on the left and on the right, respectively). As a result, the substrate (film) should preferably have an extremely low roughness. If this is not possible, it is recommended to apply a planarization layer under the first vapor-deposited layer. As mentioned, this may also be embodied as an inorganic-organic polymer hybrid layer.

The simplest method for producing such a structure is combining two inorganic coated substrate films via an inorganic-organic (hybrid polymer) adhesive layer (laminating layer) with the inorganic layers against one another (PET/inorganic layer/hybrid polymer adhesive/ . . . ) or via a conventional laminating adhesive with the hybrid polymers against one another (PET/inorganic layer/hybrid polymer/commercially available laminating adhesive/ . . . ). As an alternative thereto, an inorganic coated substrate film with an inorganic-organic hybrid material can be lacquered and be provided with another inorganic layer. Further layers may follow in alternating sequence. Both methods can be used for the present invention.

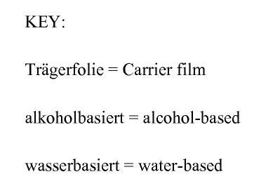

Water-based UV-curable barrier coating materials are used in a preferred embodiment of the present invention. UV-curable, inorganic-organic hybrid polymers used up to now were exclusively sol-gel-crosslinked in the presence of alcohols. Surprisingly, it could be determined that the replacement of alcohol-based barrier lacquers with water-based lacquers of water-based systems in the composite systems according to the present invention leads to an improvement in the vapor barrier properties. It is clear from FIG. 3 that the oxygen permeability was almost unchanged, while the water vapor permeability dropped to half (system a designates lacquer (A), system b designates lacquer (B) of Example 1).

In another, also preferred embodiment of the present invention, barrier lacquers made of inorganic-organic hybrid material are used, which additionally contain particles, especially oxide particles. It is especially preferred to implement this embodiment with organic crosslinkable hybrid materials. As particles, aluminum oxide and/or silicon oxide particles are preferred; preferably the particle size lies in the range below the diameter of the barrier layer made of inorganic-organic hybrid material and preferably in the range of 20 nm to 120 nm, especially 30 nm to 100 nm, and more preferably approx. 50 nm. Because of the small diameter of these particles, they cannot be simply worked homogeneously into the barrier lacquers of the present invention. However, this was possible by using water-based or alcohol-based SiO₂ sols as well as an aqueous dispersion of Al₂O₃ particles. The SiO₂ particles could be worked in both in lacquer systems curing thermally and in those using light (UV) up to an amount of approx. 5-30 wt. %, especially 5-6 wt. % or—in UV-curing systems—up to approx. 11 wt. %. The systems modified with filler were applied to PET/SiOx (sputtered) and PET/AlOx (sputtered) films. The results are shown in Table 3. A reduction in the transparency of the films coated with particle-containing systems compared to the coatings without particles could not be found in the concentration ranges investigated.

A thermally curing system (carried out with lacquer (A) of Example 1) in combination with SiO₂ particles showed a further reduction in the OTRs by a factor of 10 and in the WVTRs by a factor of 2.5 (see Table 3).

TABLE 3

| | WVTR (23° C., | ORT (23° C., |
|---|---|---|
| Film sample | 85% RH) | 50% RH) |
| PET/SiOx | 0.1 | 0.2 |
| PET/SiOx/lacquer (A) | 0.05 | 0.01 |
| PET/SiOx/lacquer (A) + SiO₂ particles | 0.003 | 0.004 |

A UV-curable lacquer also achieved the measuring limit for the OTRs: 0.005 cm³/m²d bar by means of the combination with SiO₂ particles. A marked improvement in the water vapor barrier properties could also be achieved compared to the starting values of >0.1 g/m²d (0.04 g/m²d).

The use of spherical and/or surface-functionalized SiO₂ particles leads to a marked further reduction of the barrier values.

Very especially preferably, water-based barrier lacquers, which additionally contain the mentioned particles, are used for the purposes of the present invention.

In a special embodiment of the present invention, sandwich systems are prepared with a higher number of alternating inorganic and inorganic-organic hybrid polymer layers. Here as well, the basic element of such systems in turn consists of a thin, inorganic-organic hybrid material layer that is embedded between two inorganic layers (metal or metal oxide layers). The same thing that was mentioned above regarding the inorganic-organic hybrid polymer layers applies to the thickness of this layer.

The barrier layers made of inorganic-organic hybrid material are, as explained above, extremely thin. The inventors succeeded in applying such thin layers successfully to the respective substrate and in curing them to well-sealing barrier layers. In this case, it should be taken into consideration that the intended barrier action can, of course, only be achieved if the barrier layer forms a closed film on the substrate, when the inorganic and possibly the organic crosslinking has taken place to a sufficient extent and when the purely inorganic barrier layer possibly located under the inorganic-organic layer is impermeable. This can be achieved by complying with one or more of the process conditions below:

1. Measurements of the dynamic viscosities revealed that the inorganic-organic hybrid lacquers in the preferably used concentrations are usually present as almost ideal Newtonian liquid. Preferably, the dynamic viscosities are between approx. 0.008 Pas and 0.05 Pas. Therefore, in an especially favorable embodiment of the present invention, coating lacquers with very low effective viscosity, for example, in the range of 0.003 Pas to 0.03 Pas are used. On the other hand, the viscosities of the laminating materials are in the range of 0.1 Pas to 200 Pas. If these values are exceeded in the production of the lacquers or laminating materials as a result of hydrolytic condensation in the sol-gel process, it is recommended to dilute them correspondingly before application. The solid content is usually not considerably above 10-20 wt. % after the dilution possibly carried out.

2. The silanes of formula (I) used have two or—preferably—three hydrolyzable groups. As a result, a relatively impermeable, inorganic network made of Si—O—Si bridges forms.

3. The silanes of formula (I) are used in combination with silanes of the formula SiX₄. This further increases the inorganic crosslinking and makes the coating more glass-like.

4. Instead of or in addition to the measure explained under point 3, hydrolyzable metal compounds, for example, of aluminum, zirconium and/or titanium can be added. As a result of this, the organic crosslinking becomes even more impermeable.

5. Organic crosslinkable silanes, for example, those with a glycidyl, anhydride or (meth-)acrylate radical, can preferably be used as silanes, whereby possibly suitable catalysts/initiators are added for an organic crosslinking of these radicals. After applying the lacquer, this [lacquer] is thermally or photochemically aftertreated, whereby, in addition to the inorganic Si—O—Si network, which is produced by hydrolytic condensation, an organic network forms. This increases the impermeability of the inorganic-organic layer for passing through gas molecules.

6. The hydrolytic condensation of the silane compounds of formula (I) preferably takes place using an acidic or basic catalyst. This may be selected such that it can be used as a complexing ligand for one or more added metal compound(s) at the same time. This slows the hydrolytic condensation down and promotes the buildup of a uniformly crosslinked structure.

7. An important factor for the success of an impermeable layer is the surface tension of the lacquer as well, since sufficient wetting on the substrate or the exclusively inorganic layer lying thereunder must be guaranteed to be able to guarantee a uniform lacquer application. This is preferably in the range of approx. 20-35 mN/m.

8. Several methods were consequently investigated as to whether the lacquer layers according to the present invention can thus be applied as closed films with the smallest possible layer thickness with an upper limit of <1 μm, because, as already mentioned above, the barrier action of the inorganic-organic hybrid polymer layers depends essentially on the closed nature of films, on an optimal crosslinking of the inorganic and of the organic network and the impermeability of the inorganic vapor-deposited layer lying thereunder.
Application methods such as beat coating, reverse gravure and curtain coating were tested. All these methods have the property of being able to apply thin layers in a closed form.
The “reverse gravure” method is carried out using a reverse screen roller application. The dynamic viscosities mentioned above under point 1 are readily suitable for this method. The structure of the inorganic-organic hybrid layer forming in this case proved to be very favorable.

9. Because of the sensitivity of the layers, it is recommended to perform the film transport without contact with the substrate (e.g., rollers). The state of the art also makes available correspondingly suitable measures for the roll-to-roll method.

10. Moreover, environmental conditions should be selected that keep the presence of dust particles or other particulate suspended matter in the air as low as possible, if not exclude same.

11. As already mentioned above, usually (additional) inorganic crosslinking steps are introduced during the evaporation of the lacquer solvent. This is connected with the chemical equilibrium of the inorganic crosslinking reaction (polycondensation). If organic crosslinkable functional groups are present, a certain activation energy is additionally needed, so that the crosslinking reactions are initiated. This can be introduced thermally or by radiation. The thermolability of the plastic films, which may deform thermoplastically at too high temperatures, may be problematic in this case. In the drying and formation of the inorganic-organic hybrid polymer layers, it is thus recommended to comply with conditions that take into account both the respective thermal resistance of the polymer film used and the curing conditions of the respective lacquer.

To take these circumstances into account, in a preferred embodiment the drying is therefore carried out with a high laminar air flow, followed by a partially throttled infrared radiation. In this case, the web temperature should be controlled such that the plastic film is not affected. For the coating of PET films, for example, usually approx. 90° C. to 120° C. should not be exceeded. Yet, it is possible to bring the temperature of the lacquer layer in the wet state markedly above this temperature, for example, by approx. 20K over it, in order to provide the needed activation energy for initiation of the organic crosslinking reaction. The most important requirement for this is the cooling caused by the evaporation, which is generated during the evaporation of the solvent. As an alternative to IR radiation, UV radiation may be used, e.g., when organic groups of the silanes of the lacquer can be crosslinked thereby.

Uncoupling of hot air drying and radiation is made considerably easier by using a separate drying station for hot air, since the individual steps can be carried out separately in two units.

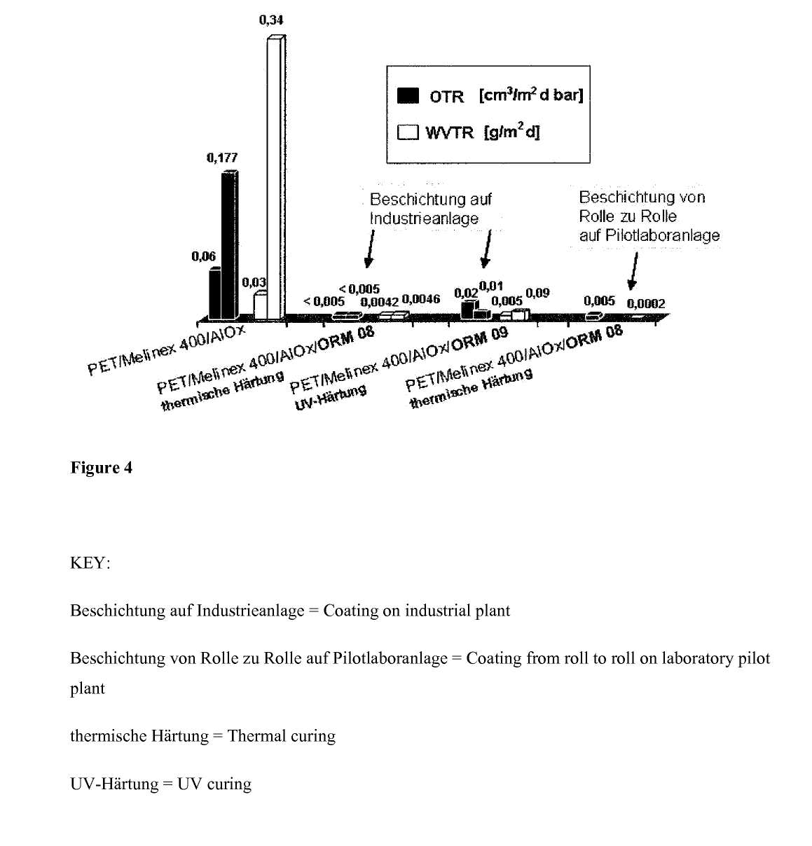

The improvements, which the roll-to-roll method using the above-mentioned measures offers, are evident from FIG. 4. The coating of a PET/Melinex 40 film, which is vapor-deposited/sputtered with AlOₓ, with the lacquer “ORM 8,” corresponding to lacquer (A) of Example 1, which was subsequently thermally cured, leads, applying these measures to a roll-to-roll pilot plant, to cutting in half of the water vapor permeability, compared with a film coated with the same materials in the same thickness according to standard methods.

### GENERAL EXEMPLARY EMBODIMENT

### Starting Materials:

10-40 mol. % tetraalkoxysilane,
10-90 mol. % organic crosslinkable silane,
5-35 mol. % metal alcoholate, selected from among aluminum, zirconium and/or titanium alcoholates.

Possibly a complexing agent in case of relatively reactive metal alcoholates, e.g., triethanolamine, acetoacetic ester, acetyl acetate, aminopropyltrialkyl silane. The metal alcohols are optimally reacted with the complexing agent and added to the silane components and hydrolyzed.

### Example 1

### Preparation of Lacquer (A)

15 mol. % tetramethoxysilane (TMOS)
20 mol. % glycidylpropyltrimethoxy silane (GLYMO)
10 mol. % zirconium propylate
10 mol. % aluminum sec.-butylate
10 mol. % acetoacetic ester.

Zirconium propylate and aluminum sec.-butylate were complexed in acetoacetic ester in order to lower their reactivity. After adding the silanes, the mixture was hydrolyzed by acid catalysis (by means of adding aqueous HCl). A relatively slow inorganic crosslinking reaction started in this case, which leads to an increase in viscosity upon letting the mixture continue to stand over several weeks.

### Preparation of Lacquer (B)

The preparation of the lacquer from the above components was repeated with the change that the alcohols released during the reaction were removed under vacuum after the synthesis and the solvent lost in this case was replaced with water.

Lacquers (A) and (B) were used to coat PET films vapor-deposited with AlOₓ (Melinex M400 from DuPont, 75 μm thick). For this purpose, the solid content of the lacquer, which had been approx. 40% beforehand, was diluted with water to approx. 10%. After application of the lacquer under contact-free transport of the films at room temperature or only a little above that and with exclusion of dust particles, the lacquers were cured by separate hot air drying at 90° C. and IR radiation for a period of, e.g., 80 sec (at 3 m/min). Some of the films were subsequently vapor-deposited with another AlOₓ layer. Some of these were in turn again coated with the same lacquer as a topcoat. The results are summarized in Table 2.

### Example 2

Example 1 was repeated; however, instead of a film vapor-deposited with AlOx, such a film was used that had been sputtered with a 200-nm-thick ZnSnOₓ layer. After application of the lacquer and the curing thereof, this was provided with a second, likewise 200-nm-thick ZnSnOₓ layer. A water vapor permeability of 2×10⁻⁴ g/m²d at 38° C., 90% RH was measured using the calcium mirror test (Table 2).

### Example 3

### Starting Materials:

55-80 mol. % methacryloxypropyltrimethoxy silane
25-45 mol. % metal alcoholate, complexed in a molar ratio of 1:0.5-1 with methacrylic acid wherein the metal alcoholate was selected from among alcoholates, especially those with 1 to 4 carbon atoms, of Al and/or Zr and/or Ti.

The mixture was hydrolyzed in a comparable manner as in claim [sic—Tr.Ed.] 1.

The lacquer coating was performed as described in Example 1, but the lacquer was not irradiated using IR radiation for supporting the curing. Instead of this, the methacryl groups were crosslinked under UV radiation with 5-6 J/cm².

1. High-barrier composite, comprising
(a) a substrate,
(b) a first layer made of an exclusively inorganic material,
(c) a first layer made of an inorganic-organic hybrid material, and
(d) a second layer made of an exclusively inorganic material,
characterized in that the layer made of an inorganic-organic hybrid material is arranged directly between the two layers made of an exclusively inorganic material and has a thickness of less than 1 μm.

2. High-barrier composite in accordance with claim 1, wherein the layer made of an inorganic-organic hybrid material has a thickness of less than 500 nm, preferably of less than 200 nm, and most preferably of less than 100 nm.

3. High-barrier composite in accordance with claim 1, wherein the first layer made of an exclusively inorganic material is arranged directly between the substrate and the first layer made of an inorganic-organic hybrid material.

4. High-barrier composite in accordance with claim 1, comprising at least two layers made of an inorganic-organic hybrid material, wherein the layers made of exclusively inorganic material and the layers made of inorganic-organic hybrid material are arranged in an alternating manner.

5. High-barrier composite in accordance with claim 1, wherein a first, exclusively inorganic layer is applied directly to the substrate or wherein another polymer layer, preferably made of an inorganic-organic hybrid material, is applied as a primer layer or planarization layer between a first, exclusively inorganic layer and the substrate.

6. High-barrier composite in accordance with claim 1, wherein the inorganic-organic hybrid material has an inorganic network and an organic network.

7. High-barrier composite in accordance with claim 1, wherein the inorganic-organic hybrid material was produced using at least one silane of formula (I)
R¹ₐR²_{b}SiX_{4-a-b} (I),
wherein R¹ is a radical that is available for an organic crosslinking, R² is an organic radical that is not available for organic crosslinking, and X denotes OH or a group which can enter into a condensation reaction under hydrolysis conditions with the formation of Si—O-M with M=metal or silicon, a and b are each 0, 1 or 2, and 4-a-b is 1, 2 or 3.

8. High-barrier composite in accordance with claim 7, wherein the inorganic-organic hybrid material was produced with the additional use of a silane of formula Si(OR²)₄, wherein R² has the same meaning as for formula (I), and/or one or more metal compounds, which can be condensed into the hybrid material, of formula M^{III}L₃ or M^{IV}L₄, wherein M^{III} denotes a trivalent metal and M^{IV} denotes a tetravalent metal, and L denotes an alkoxy group or a complex ligand or a tooth of a polydentate complex ligand.

9. High-barrier composite in accordance with claim 7, wherein as the silane of formula (I), up to at least 50 mol. %, preferably up to at least 80 mol. % and very especially preferably up to 100 mol. % of such a silane is used, in which 4-a-b is 3.

10. High-barrier composite in accordance with claim 7, wherein in the silane of formula (I), a is 1, and wherein an organic network is formed preferably with an epoxide ring opening or after UV radiation of an acrylate- or vinyl-group-containing radical R¹.

11. High-barrier composite in accordance with claim 7, wherein the inorganic-organic hybrid material was produced according to the water-based sol-gel process.

12. High-barrier composite in accordance with claim 1, wherein the inorganic-organic hybrid material has oxide particles with a diameter of 20-120 nm.

13. Method for the production of a high-barrier composite in accordance with claim 1, characterized in that the layers made of an inorganic-organic hybrid material are applied to the substrate possibly already coated with an inorganic material by means of applying a lacquer material with a viscosity of 0.002 Pas to 0.02 Pas and/or with a surface tension in the range of 25 mN/m to 35 mN/m or a laminating material with a viscosity of 0.1 Pas to 200 Pas, wherein
the substrate is transported under a dispensing device, from which the lacquer material/laminating material is applied to the substrate,
the substrate is transported without contact with the means effecting the transport, and
possibly the presence of dust particles is largely suppressed during the application.

14. Method in accordance with claim 13, wherein the high-barrier composite has the form of a film that can be rolled up, and the lacquer material/laminating material is applied from roll to roll.

15. Method in accordance with claim 13, characterized in that the lacquer material or laminating material was produced using silanes, which contain an organic crosslinkable group, and in that, after applying this material to the substrate, the layer formed thereby is treated in such a way that present organic crosslinkable groups form an organic network.

16. Method in accordance with claim 15, characterized in that organic groups are crosslinked by means of heat input and possibly by means of radiation.
